(19) United States
(12) Patent Application Publication
(10) Pub. No.: US 2023/0283532 A1
(43) Pub. Date: Sep. 7, 2023

(54) PERSONALIZED SERVICE-LEVEL AGREEMENTS FOR AN ELECTRONIC REQUEST MANAGEMENT SYSTEM

(71) Applicant: Okta, Inc., San Francisco, CA (US)

(72) Inventors: Ankit Goyal, Bangalore (IN); Zachary Thomas Hart, San Francisco, CA (US); Jose Solano, Thompson's Station, TN (US); Tanya Butani, Dublin, CA (US); William Stone Potter, Truckee, CA (US); Suchit Agarwal, Jersey City, NJ (US); Pratyus Patnaik, Los Altos, CA (US)

(21) Appl. No.: 17/686,169

(22) Filed: Mar. 3, 2022

(51) Int. Cl. H04L 41/5006; H04L 41/5074

(52) U.S. Cl. CPC H04L 41/5006; H04L 41/5074

(57) ABSTRACT

An organization has or uses an SLA system that selects a service-level agreement (SLA) that should apply to a given user request. The SLA system then can monitor the state of the ticket created based on the user request and provide messages or other feedback to the agent to aid the agent in meeting any performance goals associated with the SLA. The SLA system can determine the SLA to associate with a given user request by inferring a type of the request and selecting the SLA based on the type, or by using a model to directly associate an SLA to a given user request, without the need to infer an intermediate type for the user request, which eliminates the need for administrators to create and maintain metadata to guide the association between types and SLAs.

### FIELD OF ART

The present invention generally relates to the field of software systems, and more particularly, to the automated determination of which service-level agreement (SLA) should be associated with a given user request in a request management system.

### BACKGROUND

Request management systems provide a means to respond to user requests that are serviced by agents, aiding agents to prioritize the requests and ensure that the requests are handled in a timely manner or that any goals associated with the requests are otherwise met. However, the determination of which SLAs should apply to any given user request may be less convenient. System administrators or other users of the system may be obliged to manually formulate, maintain, and revise substantial metadata permitting the system to select a given SLA for a given user request. This is tedious and error-prone, requiring considerable administrator time and potentially leading to system errors.

### BRIEF DESCRIPTION OF DRAWINGS

FIG. 1 illustrates one embodiment of a computing environment in which a service-level agreement (SLA) system responds to service requests from users, issuing service tickets for responding to the service requests, informing agents who will respond to the user service requests, and monitoring the status of the service tickets to facilitate their being handled within their associated timing targets.

FIG. 2 illustrates the interactions that take place between the various entities of FIG. 1 when a user makes a user request that results in a service ticket, according to one embodiment.

FIG. 3 is a high-level block diagram illustrating physical components of a computer used as part or all of (for example) the SLA system, the client devices, and/or the messaging system of FIG. 1, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

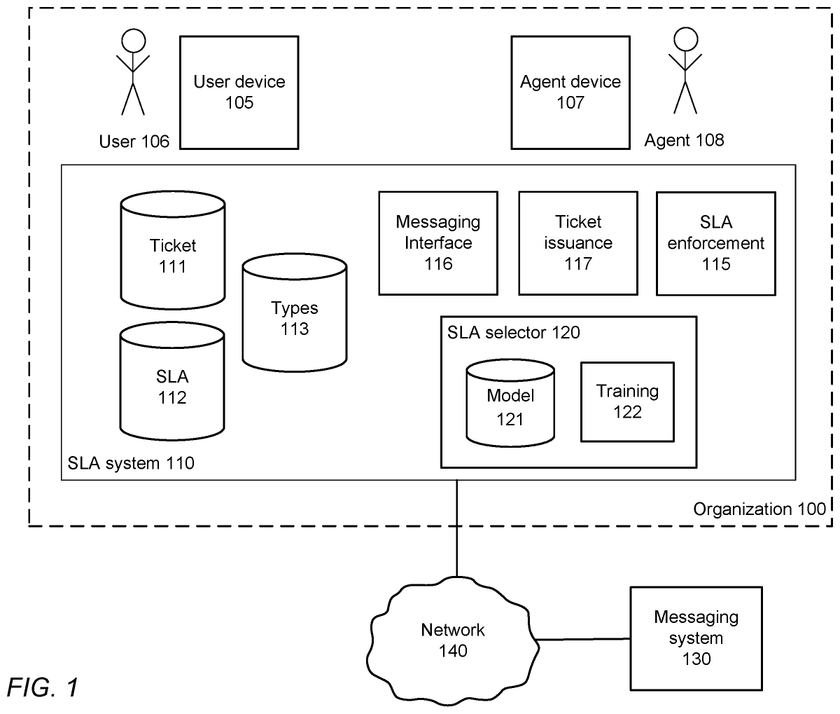

FIG. 1 illustrates one embodiment of a computing environment in which a service-level agreement (SLA) system responds to service requests from users, issuing service tickets for responding to the service requests, informing agents who will respond to the user service requests, and monitoring the status of the service tickets to facilitate their being handled within their associated timing targets.

Users 106 are affiliated with an organization 100 (e.g., as employees or volunteers of the organization) and may use their user devices 105 to access the computing system of the organization. The users 106 may encounter issues that need to be resolved by other members of the organization assigned to respond to such issues. These other members of the organization 100 are referred to as “agents” 108, and use their agent devices 107 to likewise access the computing system of the organization. The user requests may relate to any number of issues, such as the computing system of the organization (e.g., resolving a problem with the network or with an application program), physical resources of the organization (e.g., obtaining a new keyboard for the user), or the like. In order to achieve a high degree of user satisfaction, the agents should resolve the user requests within a reasonable amount of time. An SLA system 110 within the organization 100 assists the agents 108 with issuing and tracking service “tickets” (data representing a particular user request and associated metadata) and satisfying whatever goal is desired for agent responses to the user requests.

The users 106 and agents 108 communicate using a messaging system, such as an external third-party messaging system 130 as illustrated in FIG. 1. Examples of the messaging system 130 could include Slack™, Microsoft Teams™, Google Chat™, or any other messaging service that allows the sending of textual or other messages. In some embodiments, the message system 130 can include an email system, such Microsoft Outlook Exchange™, Gmail™, or the like, or a voice-based system that can convert user speech to text. The messaging system 130 may be accessed on client devices 105, 107 via a browser user interface provided by the messaging system 130, by a native application that interfaces with the messaging system 130 backend, or the like. Users 106 may also make a request of the agents 108 using the messaging system 130. For example, as an alternative to calling an agent on the telephone, a user 106 could send a message on Slack™ with the text “I need a new keyboard” to a group of agents 108, who would respond by locating an appropriate keyboard and providing it to the user.

The SLA system 110 includes a number of components used to support the handling of user requests by agents. A messaging interface 116 obtains user messages from the messaging system 130 and uses an SLA selector 120 to select, from the SLA repository 112, an SLA that is appropriate for that message. A ticket issuance module 117 creates a new ticket according to the contents of the user message and the selected SLA and stores it in the ticket repository 111. An SLA enforcement module 115 monitors the active tickets to help ensure that the agents handle the tickets in a timely manner. These components are now discussed in more detail.

The types repository 113 contains a set of known types of requests that a user can make. Some examples of types for a given organization 100 might be “Application access request” (representing a request for a particular user to be able to use a particular application), “Badge access request” (representing a request to add rights to particular rooms or other locations to access rights of a user's badge), “Broken computer” (indicating a request for replacement computer), or the like. The types repository may be populated by an administrator or other user of the organization 100, for example.

The SLA repository 112 contains the different possible SLAs that could be assigned to a given ticket. An SLA (service-level agreement) defines an expected level of service for the servicing of a particular user request. In some embodiments, an SLA includes a goal to be met, including a metric type, an explicit or implicit condition, and a value of that metric. For example, the metric type might be response time (for an agent to acknowledge the user request), a resolution time (for an agent to resolve the user request), a pending time, or the like. The metric value is of a type corresponding to the metric, such as a number of minutes or seconds for the “response time” metric type. The condition may be implicit, such as an implicit “less than or equal to” value for the “response time” metric type. An SLA may also have an associated applicability condition, which is a predicate defined in terms of contextual variables and constant values and that defines circumstances in which the SLA is applicable to a given request. For example, one particular applicability condition might be “DAY IS Saturday OR Sunday”, expressing that the SLA only applies on the weekend; “REQUESTOR MEMBEROF Executives”, expressing that the SLA only applies to users who belong to the “Executives” group within the organization 100; or “TYPE IS ‘Broken computer’ AND USER IS ‘jsmith’” expressing that the SLA applies only if the request type is “Broken computer” and the user has the username “jsmith”. Applicability conditions may be arbitrarily complex, with any number of subexpressions. In some embodiments, an SLA may additionally have an assigned request type (e.g., as an explicit or implicit portion of the applicability condition) from the types repository 113; in other embodiments (as discussed below) SLAs are more decoupled from types, with SLAs not expressly coupled to particular types, and with tickets being matched with an SLA using a machine-learned model, rather than matching purely upon types expressly assigned to SLAs. In some embodiments, SLAs may additionally have data including a list of one or more agents 108 or other users 106 to be notified in response to events associated with an SLA assigned to a ticket (such as the goal associated with the metric being breached), and/or a tag to apply to a ticket with the given SLA when the SLA is breached.

The ticket repository 111 stores data for service tickets representing particular user requests and associated metadata. In some embodiments, each ticket has one or more associated types from the types repository 113. The type may be assigned explicitly and manually by an agent 108 of the organization 100, such as by the agent selecting one of the types from a user interface provided by the SLA system 110 and choosing an option to create a new ticket of that type, or explicitly and automatically by a machine-learned model or other logic of the SLA system 110 that maps a ticket to an SLA to be associated with it. In other embodiments, the ticket need not have an explicit type, instead automatically being assigned an SLA by the SLA selector module 120, rather than being assigned an SLA partially or purely via a type associated with the ticket.

In some embodiments, the SLA system 110 includes a messaging interface 116 that obtains user messages from the messaging system 130, so that the messages may be analyzed to determine whether they represent a user request for which a ticket should be issued. In some embodiments, the messaging interface is implemented as a plugin or other form of extension that operates in conjunction with the messaging system 130 to obtain information on messages of the organization that are passing through the messaging system 130. The messaging interface may pass all or some (e.g., a subject line, thread name, or message body text) of the message data to the SLA selector module 120.

The SLA selector module 120 determines which SLA should be applied to a given ticket. The determination may be made in different manners in different embodiments. In some embodiments, each ticket has an associated type, and the SLA selector module 120 selects an SLA for a given ticket purely based on the ticket's associated type. In this embodiment, there must be a mapping from types to SLAs. For example, the type “Application access request” could be statically mapped to a particular SLA specifying a resolution time of at most 60 minutes. A requirement on administrators of the organization to create a static mapping from types to SLAs constitutes an extra burden on administrators. In other embodiments, the SLA selector module 120 selects an SLA for a ticket by evaluating the applicability conditions of the various SLAs and seeing whether the ticket data satisfies those applicability conditions. The type, and/or user identifier, may be part of the applicability condition, and so may at least in part determine the SLA in this embodiment.

In still other embodiments, such as that illustrated in FIG. 1, the SLA selector module 120 determines an SLA for a given user request/ticket by applying a machine-learned model to map directly from the request/ticket to an SLA. Advantageously, this embodiment frees administrators from the need to establish (and review, and update) a static mapping from types to 113 to SLAs 112. In this embodiment, the SLA selector module 120 has an ML model 121 that accomplishes the mapping, and (in some embodiments) a training module 122 that trains the model 121 based on a training set. In various embodiments, the features that the model 121 takes as input include: text (e.g., title, body) of a request message from the messaging system 130 that was used to derive the ticket for which the SLA is to be assigned, time/day of the request, ID of the user that specified the request, metadata associated with the user (e.g., job title, job rank), type of the request (if one is determined), and the like. Thus, in this embodiment the request type, and the user ID of the requestor, can at least partially determine the SLA for a ticket, in that they act as features for the ML model 121. In embodiments in which a training module 122 is used to train the ML model 121, a training set is formed, including a positive training set of tickets in which each ticket is labeled with an SLA that is believed to apply to that ticket. The SLA that applies to a given ticket may be determined by prior logging by the SLA selector module 120 of the SLAs that agents 108 or other users select for a given ticket. (In some embodiments, the agent 108 to whom a given ticket is assigned—or an administrator—is permitted to select the SLA for that ticket, either by assigning an SLA for a ticket lacking any system-determined SLA, or by changing the SLA for a ticket whose initial SLA selection was made by the SLA selector module 120. This selection by the agent 108 (or other user) of an SLA for a ticket constitutes the “ground truth” that that SLA is indeed applicable to that ticket, and thus that the ticket should be associated with that SLA in the positive training set.)

With an SLA determined for a given user request (or prior to or concurrent with the SLA determination), the ticket issuance module 117 generates a ticket for the user request, setting the SLA for the ticket to the SLA determined by the SLA selector module 120. The ticket is stored in the ticket repository 111, and may either then or later be assigned to an agent 108.

The SLA enforcement module 115 monitors the active (unresolved) tickets within the ticket repository 111 and provides feedback to the agents 108 to help to ensure that the goal of the ticket is met. For example, in the case of time-based goals, the SLA enforcement module 115 could issue a warning at a given point before the time-based deadline for the ticket (e.g., when 75% of the allowable time has elapsed), or when the ticket deadline has been reached, or at some point or multiple points after the ticket deadline has been reached, or any combination thereof. The SLA enforcement module 115 may use the messaging interface 116 to send the warning via the messaging system 130 (e.g., sending a Slack™ message to an assigned agent 108 or manager thereof, warning “[SLA violation] The ticket #189893 has only 5 minutes left til the completion deadline.”) Alternatively, instead of sending a message, the SLA enforcement module 115 can update a user interface provided to agents 108 by the SLA system 110, e.g., adding a visual flag that the deadline for that particular ticket is near.

In some embodiments, a multi-tenant system (not illustrated in FIG. 1) handles SLA and ticketing functionality for the tenant organizations that use the multi-tenant system. In these embodiments, the multi-tenant system has data for each tenant organization, corresponding to the data items 111, 112, 113, and 121, each of which may be organization-specific, and the organization also has its own users 106, 108 and devices 105, 107. Each organization may also use its own messaging system 130, and hence the messaging interface 116 needs to support each of the messaging systems.

Physically, the organization 100 is made up of a number of computing systems, including the various client devices 105, 107; one or more internal networks that connects the computing systems, including routers or other networking devices that define the boundary between the organization and external networks; and the like.

Similarly, the messaging system 130, although depicted as a single logical system in FIG. 1, may be implemented using a number of distinct physical systems and the connections between them, such as application servers, database servers, load-balancing servers, routers, and the like.

The network 140 may be any suitable communications network for data transmission. In an embodiment such as that illustrated in FIG. 1, the network 140 uses standard communications technologies and/or protocols and can include the Internet. In another embodiment, the entities use custom and/or dedicated data communications technologies.

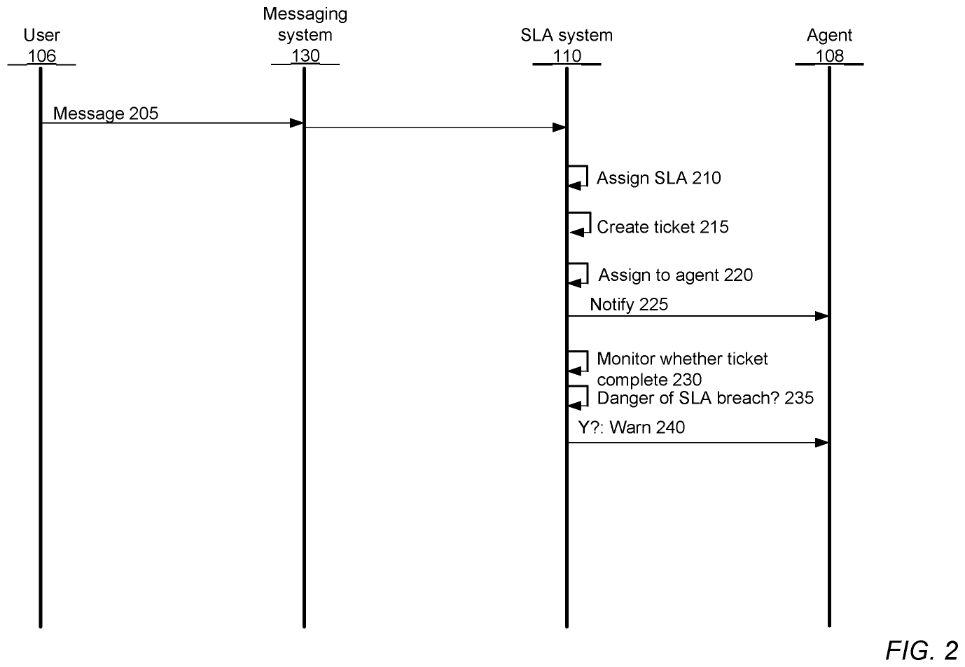

FIG. 2 illustrates the interactions that take place between the various entities of FIG. 1 when a user makes a user request that results in a service ticket, according to one embodiment.

The user 106 uses the user device 105 to send 205 a message embodying the user request. For example, the user 106 might send a Slack™ message over the messaging system 130 containing the body text “My laptop broke. I need a new computer.” The message is obtained by the SLA system 110 (e.g., by its messaging interface), and the message data is provided to the SLA selector module 120, which determines an SLA from the SLA repository 112 that is most appropriate for the user request. As noted above with respect to the SLA selector module 120, in various embodiments the SLA is determined based solely on a type associated with the user request (where an agent 108 may specify the type, or a machine learning model may map the message data to a type), or is determined based on matching a ticket with SLA applicability conditions, or is determined by mapping the ticket or message data directly to an SLA using the model 121.

The SLA system 110 creates 215 a ticket for the user request, assigning the SLA determined by the SLA selector module 120 as the SLA for that ticket. The SLA system may assign 220 the ticket to an agent 108 for resolution, and notify 225 the agent of the assignment (e.g., by sending a message through the messaging system 130, by updating a user interface displayed to the agent, or the like).

With the ticket assigned 220, the SLA system monitors 230 whether the assigned agent has resolved the ticket yet (i.e., completed the task corresponding to the user request), e.g., by determining whether the agent has marked the ticket as closed using a user interface. If not, the SLA system determines whether a deadline associated with the ticket is approaching (or arrived, or past), and if so issues 240 an appropriate warning to the agent, as discussed above with respect to the SLA enforcement module 115 of FIG. 1.

It is noted that the interactions of FIG. 2 may occur in a different order than those illustrated, or need not occur, in different embodiments. As just one example, the data structure for a ticket may be created 215 at an earlier time than the assignment 210 of an SLA to that ticket

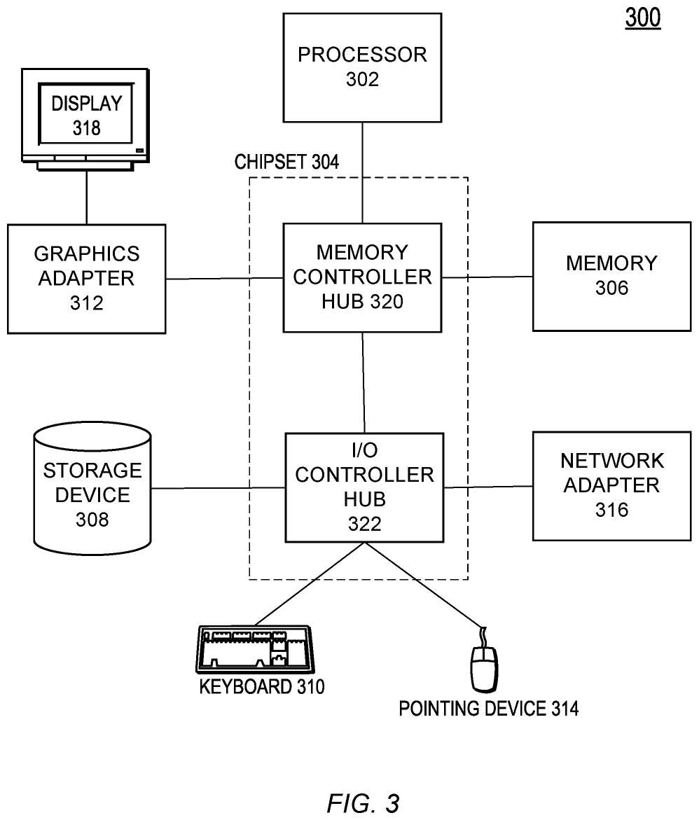

FIG. 3 is a high-level block diagram illustrating physical components of a computer 300 used as part or all of (for example) the SLA system 110, the client devices 105, 107, and/or the messaging system 130 of FIG. 1, according to one embodiment. Illustrated are at least one processor 302 coupled to a chipset 304. Also coupled to the chipset 304 are a memory 306, a storage device 308, a graphics adapter 312, and a network adapter 316. A display 318 is coupled to the graphics adapter 312. In one embodiment, the functionality of the chipset 304 is provided by a memory controller hub 320 and an I/O controller hub 322. In another embodiment, the memory 306 is coupled directly to the processor 302 instead of the chipset 304.

The storage device 308 is any non-transitory computer-readable storage medium, such as a hard drive, compact disk read-only memory (CD-ROM), DVD, or a solid-state memory device. The memory 306 holds instructions and data used by the processor 302. The graphics adapter 312 displays images and other information on the display 318. The network adapter 316 couples the computer 300 to a local or wide area network.

As is known in the art, a computer 300 can have different and/or other components than those shown in FIG. 3. In addition, the computer 300 can lack certain illustrated components. In one embodiment, a computer 300 acting as a server may lack a graphics adapter 312, and/or display 318, as well as a keyboard 310 or pointing device 314. Moreover, the storage device 308 can be local and/or remote from the computer 300 (such as embodied within a storage area network (SAN)).

As is known in the art, the computer 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 308, loaded into the memory 306, and executed by the processor 302.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Other Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

1. A computer-implemented method of assigning SLAs for responding to user requests, comprising:
receiving a request from a user over a messaging system, the request containing text;
providing at least the text, an identity of the user, a type of the request, and a time of the request, as input to a machine-learned model;
selecting, using the machine-learned model, a service-level agreement (SLA) to apply to the request, the SLA having an associated goal;
generating, for the request, a service ticket that is associated with the selected SLA;
determining an agent to be assigned to the service ticket;
monitoring handling of the service ticket to determine whether a deadline associated with the ticket is approaching; and
responsive to determining that the deadline associated with the ticket is approaching, using the messaging system to provide a warning to the agent of potential breach.

2. A computer-implemented method of assigning SLAs for responding to user requests, comprising:
receiving a request from a user;
based on at least an identity of the user and a type of the request, using a machine-learned model, selecting a service-level agreement (SLA) to apply to the request; and
monitoring handling of the request to determine whether the SLA is being met.

3. The computer-implemented method of claim 2, wherein the SLA has a goal including a metric type and a value for the metric.

4. The computer-implemented method of claim 2, wherein the SLA an applicability condition that determines whether the SLA is applicable to the request.

5. The computer-implemented method of claim 2, wherein the SLA is selected to apply to the request by providing at least the identity of the user and the type of the request as input to a machine-learned model that identifies an applicable SLA.

6. The computer-implemented method of claim 5, further comprising:
presenting the selected SLA in a graphical user interface to an agent handling the request;
noting that the agent selected an SLA different from the selected SLA for the request;
including the different SLA in a training set; and
retraining the machine-learned model using the training set.

7. The computer-implemented method of claim 2, wherein the SLA is selected based on a predetermined mapping of request types to SLAs.

8. The computer-implemented method of claim 2, further comprising determining the type of the request by applying a machine-learned model to text associated with the request.

9. The computer-implemented method of claim 2, wherein the request from the user is specified in a textual message sent via a messaging system.

10. A computer system comprising:
a computer processor; and
a non-transitory computer-readable storage medium storing instructions that when executed by the computer processor perform actions comprising:
receiving a request from a user;
based on at least an identity of the user and a type of the request, using a machine-learned model, selecting a service-level agreement (SLA) to apply to the request; and
monitoring handling of the request to determine whether the SLA is being met.

11. The computer system of claim 10, wherein the SLA has a goal including a metric type and a value for the metric.

12. The computer system of claim 10, wherein the SLA an applicability condition that determines whether the SLA is applicable to the request.

13. The computer system of claim 10, wherein the SLA is selected to apply to the request by providing at least the identity of the user and the type of the request as input to a machine-learned model that identifies an applicable SLA.

14. The computer system of claim 13, the actions further comprising:
presenting the selected SLA in a graphical user interface to an agent handling the request;
noting that the agent selected an SLA different from the selected SLA for the request;
including the different SLA in a training set; and
retraining the machine-learned model using the training set.

15. The computer system of claim 10, wherein the SLA is selected based on a predetermined mapping of request types to SLAs.

16. The computer system of claim 10, the actions further comprising determining the type of the request by applying a machine-learned model to text associated with the request.

17. The computer system of claim 10, wherein the request from the user is specified in a textual message sent via a messaging system.
